(19) United States
(12) Patent Application Publication
(10) Pub. No.: US 2006/0157327 A1
(43) Pub. Date: Jul. 20, 2006

(54) Rotating button and electronic device utilizing the same

(75) Inventors: Chi Wen Chou, Taipei County (TW); Yi Ting Liu, Kaohsiung County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/335,096

(22) Filed: Jan. 18, 2006

(30) Foreign Application Priority Data
Jan. 19, 2005 (TW) TW94101523

(51) Int. Cl. H01H 19/00

(52) U.S. Cl. 200/14; 116/213

(57) ABSTRACT

An electronic device includes a housing and a rotating button disposed on the housing. A first rotation member includes a first protrusion. A second rotation member is connected to the first rotation member in a rotatable manner. When the second rotation member is rotated, the first rotation member is rotated along with the second rotation member. A moving member is moveably disposed between the first rotation member and the second rotation member, and includes a second protrusion. The shape of the second protrusion corresponds to the shape of the first protrusion so that the moving member can be simply stable at an idle position. An elastic member is disposed between the moving member and the second rotation member.

### BACKGROUND

The invention relates to an electronic device and a rotating button thereof, and in particular, to a rotating button that can be accurately located at a predetermined position.

In an electronic device such as a camera, a rotating button is typically provided for selecting an operational mode. That is, the user can select different operational modes via the rotating button.

In general, a conventional rotating button comprises a plastic member and a metal elastic member. When selecting modes, the metal member rubs against the plastic member to generate stepwise rotation. Due to the friction between the plastic member and the metal member, however, the plastic member may be easily damaged; thus, particles generated thereby may fall into the electronic device. Additionally, since the shape of the metal member is limited, the stepwise rotation can only be generated by the interference between the metal member and the plastic. When the rotating button is rotated, it may accidentally locate between two operational modes due to the force balance between the metal member and the plastic member. Thus, an incorrect operational mode may be selected.

### SUMMARY

Electronic devices are provided. An exemplary embodiment of an electronic device comprises a housing and a rotating button disposed on the housing. The rotating button comprises a first rotation member, a second rotation member, a moving member, and an elastic member. The first rotation member comprises a first protrusion. The second rotation member is connected to the first rotation member in a rotatable manner. When the second rotation member is rotated, the first rotation member is rotated along with the second rotation member. The moving member is moveably disposed between the first rotation member and the second rotation member, and comprises a second protrusion. The shape of the second protrusion corresponds to the shape of the first protrusion so that the moving member is stable at an idle position. The elastic member is disposed between the moving member and the second rotation member. When the first rotation member is rotated, the moving member is moved by a relative movement between the first protrusion and the second protrusion. When the first rotation member is stopped and the moving member returns to the idle position, the first protrusion is closely adjacent to the second protrusion.

Furthermore, the housing comprises a first guiding portion, and the moving member comprises a second guiding portion corresponding to the first guiding portion so that the moving member moves in a predetermined direction. Note that the first guiding portion may be a groove, and the second guiding portion may be a rib. Additionally, the first protrusion may be saw-tooth shaped or wave shaped, and the second protrusion is symmetrical with the first protrusion.

Moreover, the rotating button further comprises a screw connecting the first rotation member and the second rotation member. The first rotation member comprises a through hole. The second rotation member comprises a screw hole corresponding to the through hole. The screw is threaded with the screw hole via the through hole.

The electronic device further comprises an electrical brush disposed on the first rotation member. The first rotation member is located inside the housing, and the second rotation member is located outside the housing. The moving member, the first rotation member, and the second rotation member may be made of plastic. The elastic member may be a compression spring.

The electronic device may be a camera, and further comprises a switch, a shutter button, and a compression spring. The switch is disposed in the housing. The shutter button is disposed on the housing, and contacts the switch selectively. The compression spring is disposed between the shutter button and the second rotation member to separate the shutter button from the switch.

### DESCRIPTION OF THE DRAWINGS

The invention can be more fully understood by reading the subsequent detailed description and examples with references made to the accompanying drawings, wherein:

FIG. 1 is a schematic view of an embodiment of an electronic device;

FIG. 2a is an exploded view of an embodiment of a rotating button;

FIG. 2b is another exploded view of the rotating button in FIG. 2a, wherein a positioning member in FIG. 2a is omitted;

FIG. 2c is a schematic view of the assembled rotating button; and

FIGS. 3a-3c are schematic views depicting the movement of the rotating button.

### DETAILED DESCRIPTION

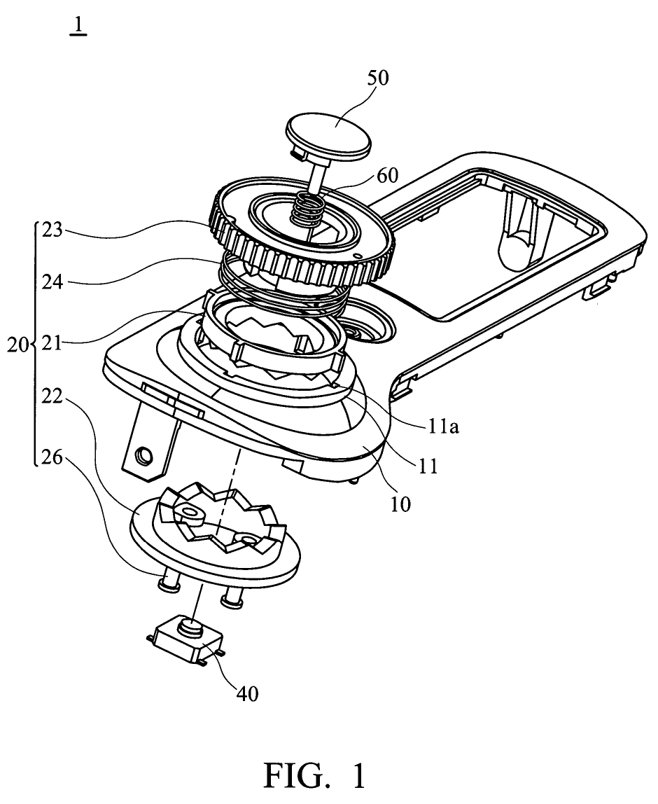

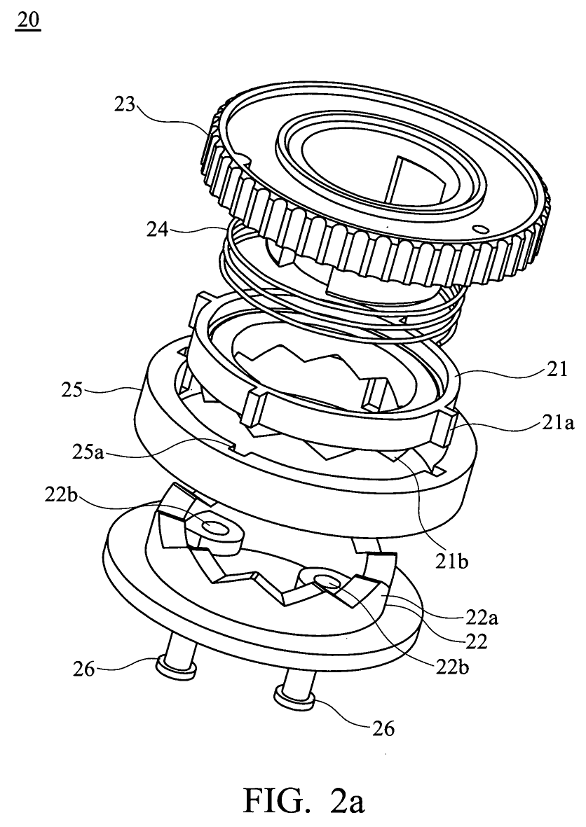

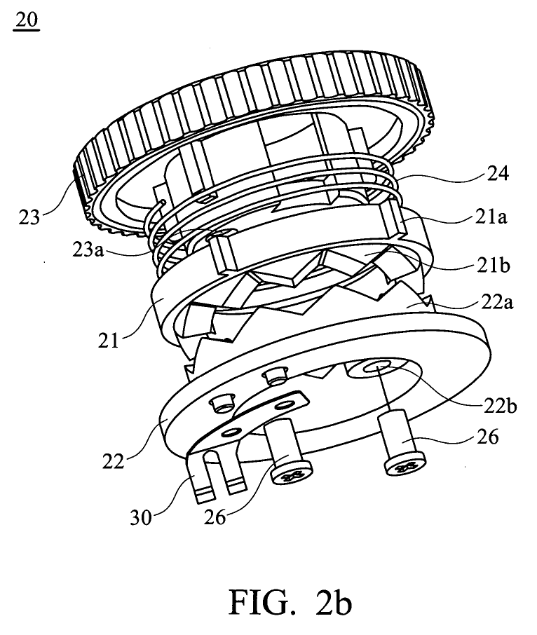

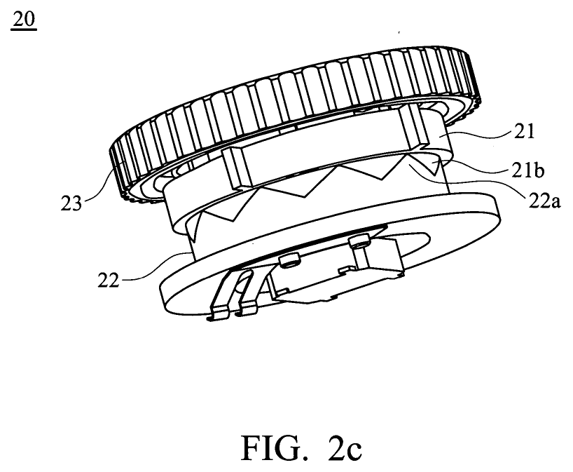

Referring to FIGS. 1 and 2b, an embodiment of an electronic device 1 comprises a housing 10 and a rotating button 20, an electrical brush 30, a switch 40, a shutter button 50, and a compression spring 60. Note that this embodiment of an electronic device 1 is a camera; however, it is not limited to this, and may be any other electronic device with a rotating button.

The housing 10 comprises a positioning portion 11 with four first guiding portions (grooves) 11a to guide a moving member 21 of the rotating button 20 to move in a predetermined direction. Note that the positioning portion 11 is integrally formed with the housing 10 in FIG. 1; however, it is not limited to this, and may be an independent member, such as a positioning member 25 as shown in FIG. 2a.

The rotating button 20 is disposed on the housing 10, and comprises a moving member 21, a first rotation member 22, a second rotation member 23, an elastic member 24, a positioning member 25, and two screws 26, as shown in FIGS. 2a-2c. The moving member 21 is movably disposed in the housing 10, and comprises four second guiding portions (ribs) 21a and a second protrusion 21b. Each second guiding portion 21a corresponds to each first guiding portion 11a so that the moving member 21 can moves in a predetermined direction. In this embodiment, the second protrusion 21b is saw-tooth shaped, however, the shape of second protrusions 21b can vary, and may be wave shaped, as long as the moving member 21 can be simply stable at an idle position.

The first rotation member 22 is located inside the housing 10, and comprises a first protrusion 22a and two through holes 22b. The first protrusion 22a abuts the second protrusion 21b, and the shapes of the first protrusion 22a and the second protrusion 21b are symmetrical. That is, the first protrusion 22a is also saw-tooth shaped. When the moving member 21 is located at the idle position as shown in FIG. 2c, the first protrusion 22a is closely adjacent to the second protrusion 21b.

The second rotation member 23 comprises two screw holes 23a, and is located outside the housing 10 so that the second rotation member 23 can be easily rotated. The second rotation member 23 is rotatably connected to the first rotation member 22 by the screws 26. When the second rotation member 23 is rotated, the first rotation member 22 is rotated along with the second rotation member 23. At this time, the moving member 21 moves in a predetermined direction by a relative movement between the first protrusion 22a and the second protrusion 21b. Additionally, the moving member 21, the first rotation member 22, and the second rotation member 23 are preferably plastic.

The elastic member 24 is a compression spring, and is disposed between the moving member 21 and the second rotation member 23 to provide a force to the moving member 21 to return the moving member 21 to the idle position as shown in FIG. 2c. The positioning member 25 in FIG. 2a is an independent member, and the structure thereof is similar with the positioning portion 11 in FIG. 1. The positioning member 25 comprises four first guiding portions 25a. Each screw 26 is threaded with the screw hole 23a of the second rotation member 23 via the through hole 22b of the first rotation member 22 to connect the first rotation member 22 and the second rotation member 23 together.

As shown in FIG. 2b, the electrical brush 30 is disposed on the first rotation member 22 to electrically connect a circuit board (not shown) in the housing 10. Referring to FIG. 1, the switch 40 is disposed in the housing 10. The shutter button 50 is disposed on the housing 10, and contacts the switch 40 selectively to actuate the switch 40. The compression spring 60 is disposed between the shutter button 50 and the second rotation member 23 to separate the shutter button 50 from the switch 40.

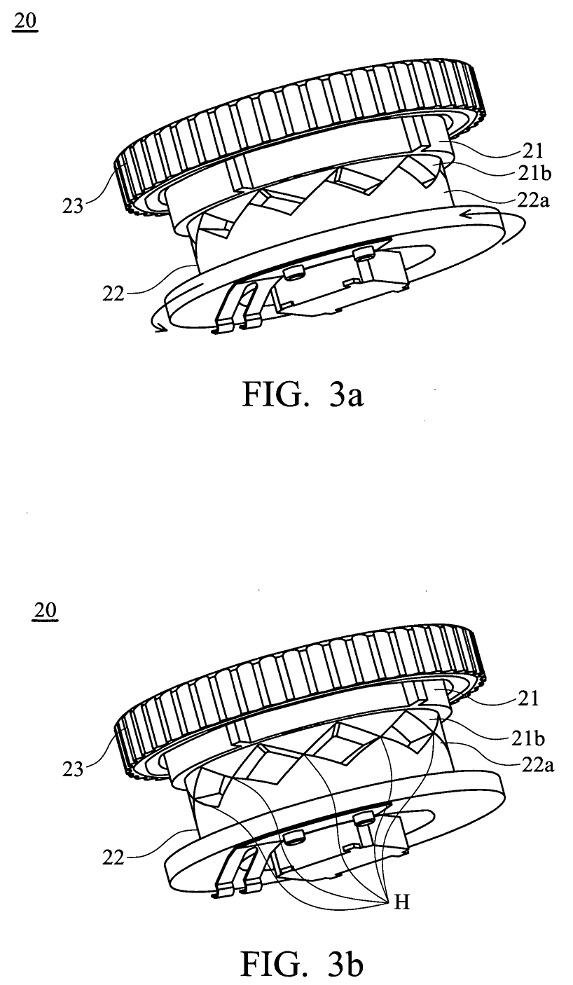

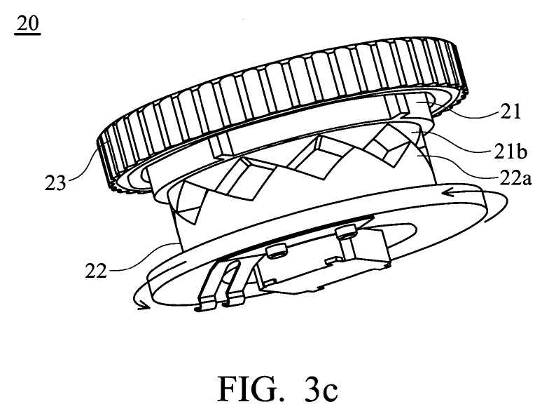

When the second rotation member 23 at the idle position is rotated, the first rotation member 22 is rotated (in the direction indicated by the arrow in FIG. 3a) together with the second rotation member 23 since the second rotation member 23 is fixed to the first rotation member 22 and the moving member 21 is restrained by the positioning member 25 or by the housing 10 in FIG. 1. At this time, the moving member 21 is moved upward along the inclined surfaces of the protrusions 21b and 22a. Note that when the rotation members 22 and 23 are stopped where the moving member 21 does not surpass highest points H as shown in FIG. 3b, the rotation members 22 and 23 will rotate in a direction opposite to the arrow A in FIG. 3a so that the moving member 21 returns to the idle position and back to the original operational mode. Conversely, when the rotation members 22 and 23 are stopped where the moving member 21 surpasses the highest points H, the rotation members 22 and 23 keep rotating along the arrow A in FIG. 3a so that the moving member 21 moves to the idle position and enters the next operational mode. Specifically, although both the moving member 21 in FIG. 3a and the moving member 21 in FIG. 3c are located at the idle position, the position of the second protrusion 21b of the moving member 21 with respect to the first protrusion 22a of the first rotation member 22 in FIG. 3c is different from that in FIG. 3a, thus, the operational mode is changed.

As previously described, in this embodiment, the stepwise rotation of the rotating button is generated by two plastic rotation members with symmetrical protrusions. Also, by the protrusions, the rotating button can be prevented from stopping between two operational modes due to force balance. Additionally, since the moving member presses the elastic member during rotation, the elastic member provides an elasticity to overcome the friction between the rotation members, thus, the smooth rotation without accidental stopping is assured.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a housing; and
a rotating button disposed on the housing, the rotating button comprising:
a first rotation member comprising a first protrusion;
a second rotation member connected to the first rotation member in a rotatable manner, wherein the first rotation member is rotated along with the second rotation member when the second rotation member is rotated;
a moving member, movably disposed between the first rotation member and the second rotation member, the moving member comprising a second protrusion, wherein the shape of the second protrusion corresponds to the shape of the first protrusion so that the moving member is stable at an idle position; and
an elastic member disposed between the moving member and the second rotation member;
wherein the moving member is moved by a relative movement between the first protrusion and the second protrusion when the first rotation member is rotated, and the first protrusion is closely adjacent to the second protrusion when the first rotation member is stopped and the moving member returns to the idle position.

2. The electronic device as claimed in claim 1, wherein the housing comprises a first guiding portion, and the moving member comprises a second guiding portion corresponding to the first guiding portion so that the moving member moves in a predetermined direction.

3. The electronic device as claimed in claim 2, wherein the first guiding portion is a groove, and the second guiding portion is a rib.

4. The electronic device as claimed in claim 1, wherein the first protrusion is saw-tooth shaped, and the second protrusion is symmetrical with the first protrusion.

5. The electronic device as claimed in claim 1, wherein the first protrusion is wave shaped, and the second protrusion is symmetrical with the first protrusion.

6. The electronic device as claimed in claim 1, wherein the rotating button further comprises a screw connecting the first rotation member and the second rotation member.

7. The electronic device as claimed in claim 6, wherein the first rotation member comprises a through hole, the second rotation member comprises a screw hole corresponding to the through hole, and the screw is threaded with the screw hole via the through hole.

8. The electronic device as claimed in claim 1, further comprising an electrical brush disposed on the first rotation member.

9. The electronic device as claimed in claim 1, wherein the first rotation member is located inside the housing, and the second rotation member is located outside the housing.

10. The electronic device as claimed in claim 1, wherein the moving member, the first rotation member, and the second rotation member are plastic.

11. The electronic device as claimed in claim 1, wherein the elastic member is a compression spring.

12. The electronic device as claimed in claim 1, wherein the electronic device is a camera.

13. The electronic device as claimed in claim 12, further comprising:
a switch disposed in the housing;
a shutter button, disposed on the housing, selectively contacting the switch; and
a compression spring disposed between the shutter button and the second rotation member to separate the shutter button from the switch.

14. A rotating button comprising:
a first rotation member comprising a first protrusion;
a second rotation member connected to the first rotation member in a rotatable manner, wherein the first rotation member is rotated along with the second rotation member when the second rotation member is rotated;
a moving member, movably disposed between the first rotation member and the second rotation member, the moving member comprising a second protrusion, wherein the shape of the second protrusion corresponds to the shape of the first protrusion so that the moving member is stable at an idle position; and
an elastic member disposed between the moving member and the second rotation member;
wherein the moving member is moved by a relative movement between the first protrusion and the second protrusion when the first rotation member is rotated, and the first protrusion is closely adjacent to the second protrusion when the first rotation member is stopped and the moving member returns to the idle position.

15. The rotating button as claimed in claim 14, further comprising a positioning member, wherein the position member comprises a first guiding portion, the moving member comprises a second guiding portion corresponding to the first guiding portion so that the moving member moves in the positioning member in a predetermined direction.

16. The rotating button as claimed in claim 15, wherein the first guiding portion is a groove, and the second guiding portion is a rib.

17. The rotating button as claimed in claim 14, wherein the first protrusion is saw-tooth shaped, and the second protrusion is symmetrical with the first protrusion.

18. The rotating button as claimed in claim 14, wherein the first protrusion is wave shaped, and the second protrusion is symmetrical with the first protrusion.

19. The rotating button as claimed in claim 14, further comprising a screw connecting the first rotation member and the second rotation member, and the first rotation member comprising a through hole, wherein the second rotation member comprises a screw hole corresponding to the through hole so that the screw is threaded with the screw hole via the through hole.

20. The rotating button as claimed in claim 14, wherein the elastic member is a compression spring.
